(19) United States
(12) Patent Application Publication
(10) Pub. No.: US 2017/0161275 A1
(43) Pub. Date: Jun. 8, 2017

(54) System and method for incorporating new terms in a term-vector space from a semantic lexicon

(71) Applicant: Luminoso Technologies, Inc., Cambridge, MA (US)

(72) Inventor: Robert Speer, Cambridge, MA (US)

(21) Appl. No.: 14/962,007

(22) Filed: Dec. 8, 2015

(51) Int. Cl. G06F 17/30

(52) U.S. Cl. CPC G06F 17/3043; G06F 17/30339; G06F 17/30401

(57) ABSTRACT

A method for incorporating new terms in a term-vector space from a semantic lexicon includes identifying, by a computing device, a first term, the first term present in a first semantic lexicon, the first term absent from a term vector space. The method includes obtaining, by the computing device, from the first semantic lexicon, at least one second term related to the first term in the first semantic lexicon. The method includes finding, by the computing device, at least one vector in the vector space corresponding to the at least one second term. The method includes generating, by the computing device, a vector corresponding to the first term using the at least one vector corresponding to the at least one second term.

### TECHNICAL FIELD

This invention relates to vector space semantic models. More particularly, the present invention relates to incorporation of new terms in a term-vector space from a semantic lexicon.

### BACKGROUND ART

Vector space models are an effective way to express the meanings of natural-language terms in a computational system. These models are created learning machine-learning algorithms that attempt to represent words or phrases as vectors in high dimensional space, such that the cosine similarity of the vectors corresponding to any two words corresponds to their semantic similarity. As machine-learning algorithms have become increasingly refined, the ability of vector similarity in such vector spaces to match the performance of human beings has increased. Nonetheless, no vector space model has yet been able to produce one hundred percent of the semantic relationships available to a typical human being. For certain kinds of tests, such as recognition of relationships between rare words, vector space models perform particularly poorly, thus far.

In view of the above, there is a need for a method to improve vector space performance, particularly with regard to rare words.

### SUMMARY OF THE EMBODIMENTS

In one aspect, a method for incorporating new terms in a term-vector space from a semantic lexicon includes identifying, by a computing device, a first term, the first term present in a first semantic lexicon, the first term absent from a term vector space represented by a term vector matrix. The method includes obtaining, by the computing device, from the first semantic lexicon, at least one second term related to the first term in the first semantic lexicon. The method includes finding, by the computing device, at least one vector in the vector space corresponding to the at least one second term. The method includes generating, by the computing device, a vector corresponding to the first term using the at least one vector corresponding to the at least one second term.

In a related embodiment, identifying further includes determining that the first term has more than a threshold number of connections to other terms within the first semantic lexicon. In another embodiment, obtaining also includes determining that the at least one second term and the first term have a connection weight exceeding a threshold number. In a further embodiment, the at least one second term is a plurality of second terms, the at least one second vector is a plurality of second vectors, each second vector corresponding to a term of the plurality of second terms, and generating also includes combining the plurality of second vectors together to generate the vector corresponding to the first term. In a further embodiment still, combining the plurality of second vectors also includes computing a mean of the plurality of second vectors. In yet another embodiment, computing the mean further involves calculating a degree of similarity between the first term and each second term and weighting each second vector of the plurality of second vectors by the degree of similarity between the first term and the second term corresponding to the second vector. In a related embodiment, calculating the degree of similarity further includes obtaining a relatedness confidence score. In an additional embodiment, combining the plurality of second vectors further includes weighting each second vector of the plurality of second vectors by a reliability score.

An additional embodiment involves performing column normalization of the term vector matrix. Anther embodiment involves performing row normalization of the term vector matrix. A further embodiment includes retrofitting the term vector space to the first semantic lexicon, producing a retrofitted term vector matrix. In a related embodiment, retrofitting further involves computing a product of the term vector space with a matrix representing the first semantic lexicon. Yet another embodiment further involves adding the retrofitted term vector matrix to the term vector matrix to produce an intermediate matrix, and computing the product of the intermediate matrix with the matrix representing the first semantic lexicon. Another embodiment, in which the matrix representing the first semantic lexicon is a square matrix having a plurality of diagonal cells, further involves weighting each diagonal cell of the plurality of diagonal cells. An additional embodiment also includes retrofitting the retrofitted term vector matrix to the first semantic lexicon. Still another embodiment further includes computing the mean of each vector in the term vector space with itself, and replacing each vector in the term vector space with the computed mean. Another embodiment also includes retrofitting the retrofitted term vector space to a second semantic lexicon. Another embodiment still involves identifying a plurality of terms in the term vector space that correspond to a single term in the first semantic lexicon and combining a plurality of vectors representing the plurality of terms together into a single vector representing the single term. In a related embodiment, combining further includes computing a weighted average of the plurality of vectors. Another embodiment still also involves generating the first semantic lexicon by combining a second semantic lexicon and a third semantic lexicon.

In another aspect, a system for incorporating new terms in a term-vector space from a lexicon includes a term vector space. The system includes a first semantic lexicon. The system includes a computing device, the computing device configured to identify a first term, the first term present in the first semantic lexicon, the first term absent from the term vector space, to obtain from the first semantic lexicon, at least one second term related to the first term in the first semantic lexicon, to find at least one vector in the vector space corresponding to the at least one second term, and to generate a vector corresponding to the first term using the at least one vector corresponding to the at least one second term.

Other aspects, embodiments and features of the disclosed system and method will become apparent from the following detailed description of the system and method when considered in conjunction with the accompanying figures. The accompanying figures are for schematic purposes and are not intended to be drawn to scale. In the figures, each identical or substantially similar component that is illustrated in various figures is represented by a single numeral or notation at its initial drawing depiction. For purposes of clarity, not every component is labeled in every figure. Nor is every component of each embodiment of the device and method is shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1A is a block diagram depicting an example of an computing device as described herein;

FIG. 1B is a block diagram of a network-based platform, as disclosed herein;

FIG. 2 is a block diagram of an embodiment of the disclosed system; and

FIG. 3 is a flow diagram illustrating one embodiment of the disclosed method.

### DETAILED DESCRIPTION OF SPECIFIC EMBODIMENTS

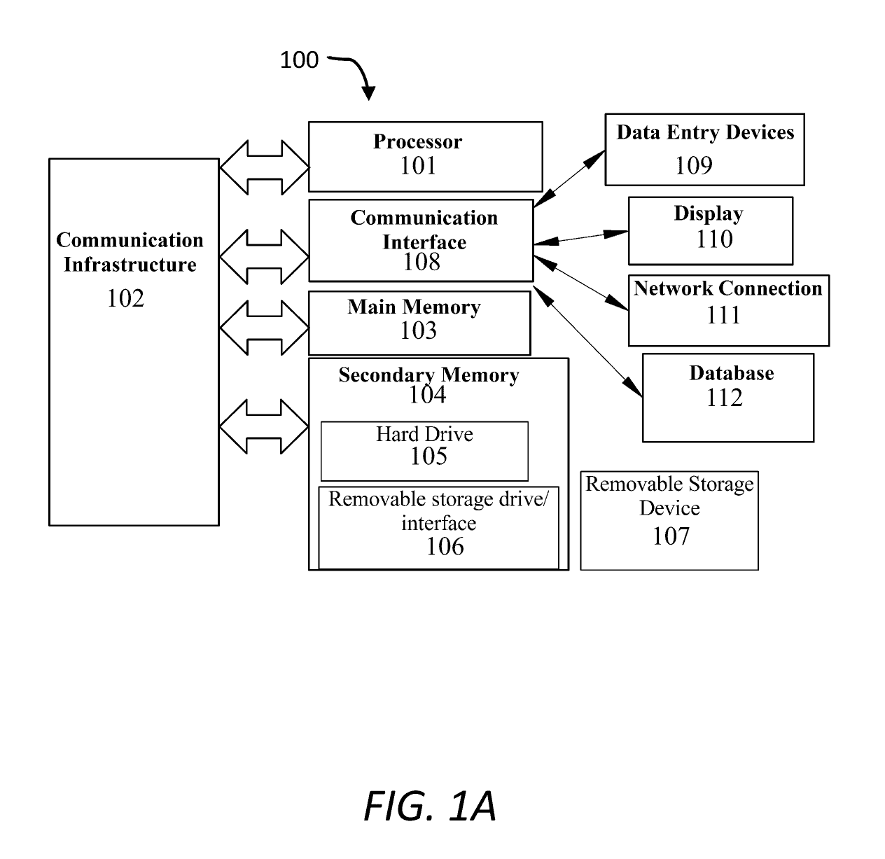

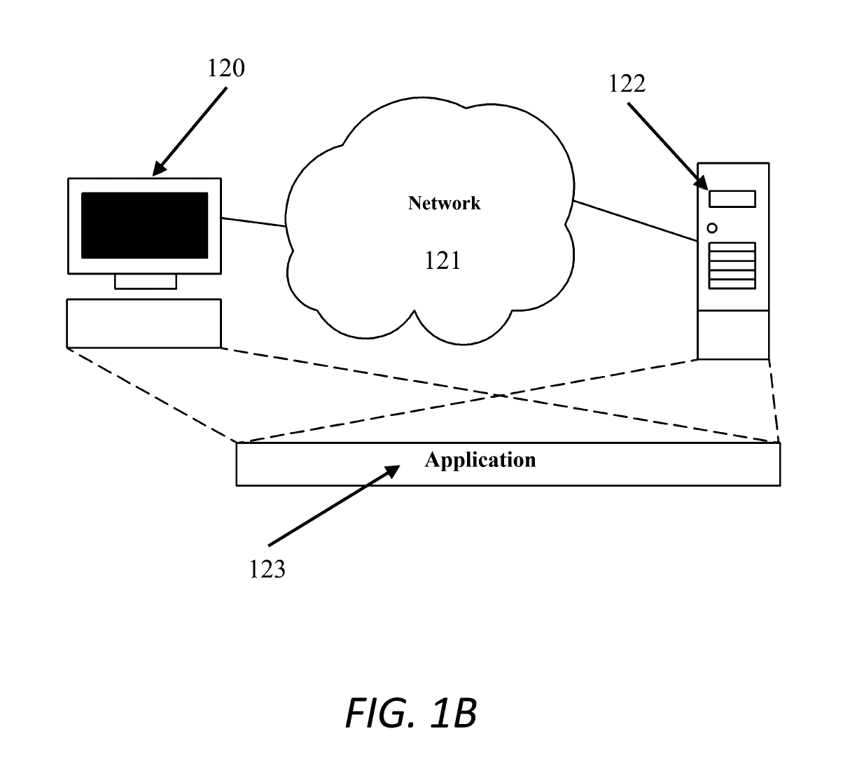

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers. In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

The one or more client devices 120 and the one or more servers 122 may communicate using any protocol according to which data may be transmitted from the client 120 to the server 122 and vice versa. As a non-limiting example, the client 120 and server 122 may exchange data using the Internet protocol suite, which includes the transfer control protocol (TCP) and the Internet Protocol (IP), and is sometimes referred to as TCP/IP. In some embodiments, the client and server 122 encrypt data prior to exchanging the data, using a cryptographic system as described above.

Embodiments of the disclosed system and methods incorporate previously absent terms into a word vector space from a semantic lexicon. The resulting vector space may have a larger vocabulary than either the term vector space or the semantic lexicon. In some embodiments, the disclosed methods also involve retrofitting the term vector space to one or more semantic lexicons; the term vector space so modified may represent word meanings in multiple languages, and may achieve state-of-the-art performance on word similarity evaluations.

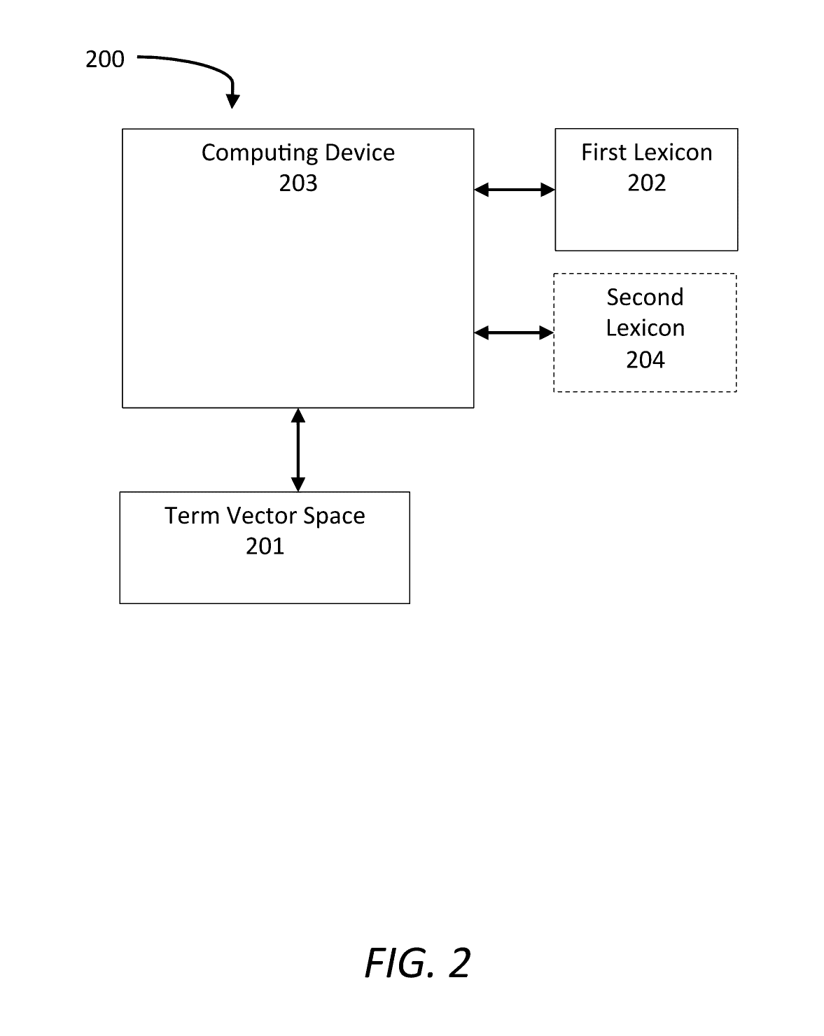

FIG. 2 illustrates an embodiment of a system 200 for incorporating new terms in a term-vector space from a semantic lexicon. As an overview, the system 200 includes a term vector space 201. The system 200 includes a first semantic lexicon 202. The system 200 includes a computing device 203.

Referring to FIG. 2 in further detail, the system 200 includes a term vector space 201. In one embodiment, a term vector space is a data set, stored in the memory of one or more computing devices, which contains a plurality of terms, and a plurality of vectors; each vector of the plurality of vectors may represent one term of the plurality of terms, and each term of the plurality of terms may be represented by one vector of the plurality of vectors. In some embodiments, a “term” is any string of symbols that may be represented as text on a computing device. In addition to single words made of letters in the conventional sense, a “term” as used herein includes without limitation a phrase made of such words, any string of numerical digits, and any string of symbols whether their meanings are known or unknown to any person.

A vector may consist of lists of numbers, where each entry in the list is called a “component” of the vector. A vector with n components may be described as an “n-dimensional vector.” The plurality of vectors may be called the “term vectors,” and each vector of the plurality of vectors may be called a “term vector.” In some embodiments, all of the plurality of vectors are contained in the same vector space, according to the mathematical definition of a vector space: a non-empty set of objects called “vectors” that is closed under the operations of vector addition and scalar multiplication. A vector space is “n-dimensional” if it is spanned by a set of n vectors. For the purposes of this application, it will be assumed that the large collections of vectors with n components contemplated by this invention will span an n-dimensional space, although it is theoretically possible that the space defined by a particular collection of n-dimensional vectors as defined herein will have fewer than n dimensions; the disclosed system and method would still function equally well under such circumstances. A “subspace” of an n-dimensional vector space is a vector space spanned by fewer than n vectors contained within the vector space. In particular, a two dimensional subspace of a vector space may be defined by any two orthogonal vectors contained within the vector space; two vectors may be orthogonal if the dot product of the two vectors is equal to zero. The proximity between two vectors in a vector space of any dimension may be calculated by taking the cosine of the two vectors, readily obtained by calculating the dot product of the two vectors; in a term vector space, terms with vectors that have high cosine similarity may be terms with high semantic similarity, and the goal of operations on the term vector space may be to ensure that vectors' cosine similarity matches strongly with terms' semantic similarity.

The term vector space may be represented by a term vector matrix in which either the columns or rows of the term vector matrix are the term vectors. For the sake of the ensuing description and claims, it is assumed that the vectors of the term vector matrix are rows, but persons skilled in the art will be aware that there is no true mathematical difference between matrix rows or columns, which are labeled as a matter of convenience or convention to make the description of matrix calculation easier to follow. The term vector matrix representing the term vector space may be a square matrix in which both the rows and columns correspond to the complete set of terms, so that the term vector space has as many dimensions as there are terms; the term vector matrix may be symmetric, so that for instance each diagonal entry represents the relationship of a term to itself. In other embodiments, the term vector matrix has been produced by one or more processes that reduce its dimensionality, so that each term vector has fewer entries than the number of total terms, and the term vector space has a lower dimensionality; for instance, there may be 100,000 terms in the term vector space, corresponding to 100,000 vectors, but each vector may have only 300 indices, so that the term vector space has 300 dimensions and the term vector matrix is 100,000 rows by 300 columns. The process for reducing the dimensions of the term vector matrix may also serve to make the relationships represented by vector proximity more accurately reflect the semantic relationships of the corresponding terms; many such processes enhance the ability of the resultant vector space to detect synonymous terms and disassociate differing meanings of polysemous terms.

As a non-limiting example, the term vector matrix may be reduced by a process including a truncated Singular Value Decomposition (SVD). SVD of a matrix A involves factoring A as follows: A=UΣU^{T}, where U is a matrix whose columns are the orthogonal eigenvectors of A, and where Σ′ is a matrix defined in terms of the eigenvalues of A, ordered in descending size and denoted as λ₁ . . . λᵢ . . . λᵣ, where there are a total of r such eigenvalues. The entries of Σ are all zero, except the first r diagonal entries from the upper left corner of the matrix, which are set to the eigenvalues like so: Σᵢᵢ=\sqrt{λᵢ}∀ i:1≦i≦r. Since all vectors on which a matrix can operate may be expressed as a linear expression of the matrix's eigenvectors, and since large eigenvalues affect eigenvectors much more strongly than small eigenvalues, if the lower-right diagonal entries of Σ are set to zero, producing Σₖ, the resulting “cropped” matrix A=UΣₖU^{T} will have a very similar effect to that of the original A with regard to transformation of vectors. Thus, producing Σₖ creates a new Aₖ that captures a great deal of the information originally in A in far fewer dimensions. The cropping process may produce a cropped Σ retaining as few as the 10 largest diagonal values in or as many as the 1000 largest diagonal values in Σ. This produces an Aₖ that is much denser than A; as intuition might predict, this produces a much higher information density.

In other embodiments, distinct or additional processes may be used for producing truncated or condensed term vector matrix. For instance, the term vector matrix may be refined by a learning algorithm which seeks to match vector behavior to one or more term behaviors, for instance by causing the term vectors's dot product to approximately equal the logarithm of the probability of two terms' co-occurrence in the corpus of documents used as the source for the term vector space. As a non-limiting example, the term vector matrix may be produced by the GloVe algorithm produced by Stanford University of Stanford, Calif., or a similar process. GloVe is an unsupervised learning algorithm that learns vector representations of words, such that the dot product of two words' vectors is approximately equal to the logarithm of their co-occurrence count. The algorithm operates on a global word-word co-occurrence matrix, and solves an optimization problem to learn a vector for each word, a separate vector for each context (although the contexts are also words), and a bias value for each word and each context. Only the word vectors are used for computing similarity. The term vectors and term vector matrix may be produced by other processes, such as that used by the WORD2VEC project headed by Google, Inc. of Mountain View, Calif., by a skip-gram process, by a continuous-bag-of-words process, a global term context method, or other processes.

A vector's “norm” is a scalar value indicating the vector's length or size. In some embodiments, the equation for the “P norm,” denoted L_{P}, of an n-dimensional vector a may be calculated according to the formula

$$‖ a ‖ = \sqrt[P]{{\sum }_{0}^{n} {a}_{i}^{P}} ,$$

where aᵢ is entry corresponding to index number i of a. Thus, for vector a, the “1 norm” L₁ may be computed as ∥a∥=Σ₀ⁿaᵢ, and the “2 norm” L₂ may be computed as ∥a∥=\sqrt{Σ₀ⁿaᵢ²}. In some embodiments, vector is “normalized” if it has been turned into a vector of length 1, or “unit vector” by scalar-multiplying the vector with the multiplicative inverse of its norm. In other words, a vector a is normalized by the formula

$$\frac{a}{‖ a ‖} ,$$

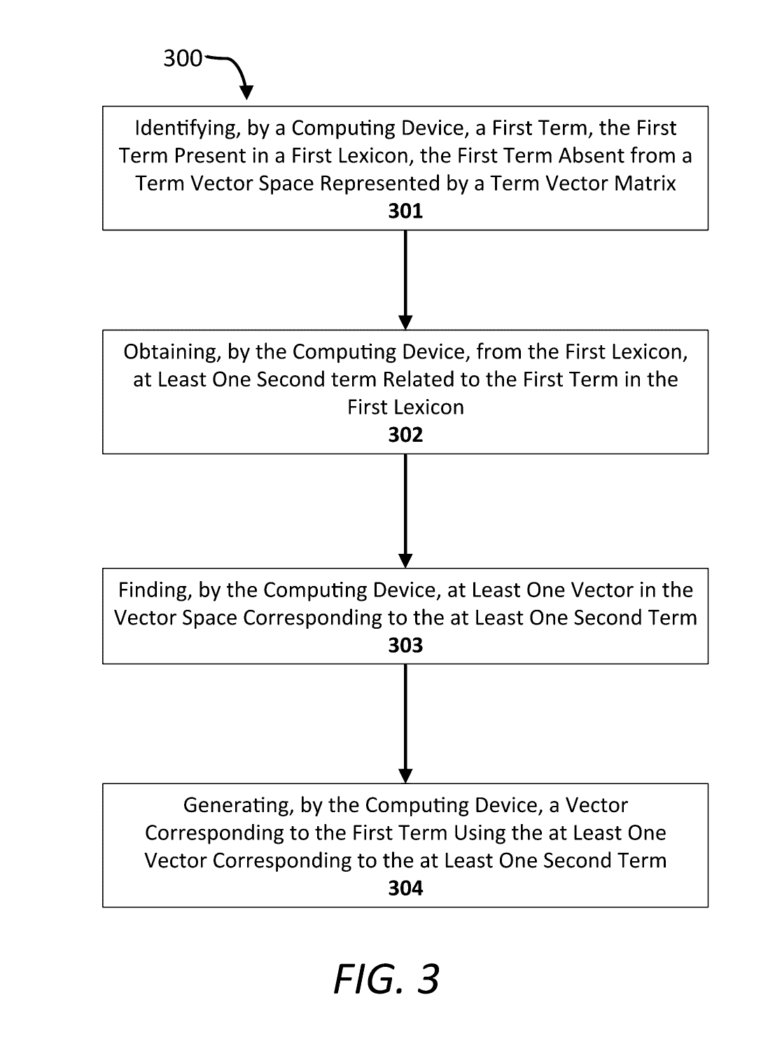

calculated by dividing each aᵢ by ∥a∥. Normalization may be performed on any row or column of a matrix; thus even where, as assumed for the discussion herein, the rows of the matrix representing the term vector space 201 are the term vectors, the columns may be normalized as well, and the norms computed as above for each column as a vector in its own right. This is referred to as “column-normalization” for the purposes of this description; normalization of the term vectors is referred to as “row-normalization” for the purposes of this description. The term vector matrix may be produced by additional processes, such as retrofitting to a semantic lexicon, as describe below in reference to FIG. 3.

The term vector space 201 may be stored in the memory of one or more computer devices. The term vector space 201 may be stored in the memory of the computing device 203. In other embodiments, the term vector space 201 is stored in memory of an additional computing device (not shown) or set of computing devices with which the computing device 203 is able to communicate.

The system 200 includes a first semantic lexicon 202. In one embodiment, the first semantic lexicon 202 is a collection of terms in which relationships between the terms are represented in an explicit manner. The relationships represented may be semantic. The representations of relationships may include, without limitation, indication of which terms are synonymous, antonymous, hypernymous, hyponymous, meronymous, holonymous, or linked by paraphrase to a given term. Thus, for instance, the term “piano” might be linked to “musical instrument” (because a piano is a musical instrument), “wood” (because some pianos are wooden), “furniture” (because a piano may be a kind of home furnishing), “upright” (a kind of piano), “grand” (another kind of piano), “clavier” (another term for piano), and so forth. In some embodiments, the semantic lexicon can be seen as a graph in which nodes represent terms and edges represent relationships between the terms. The graph may have the properties of a Markov random field. As a non-limiting example, the first semantic lexicon 202 may include ConceptNet, which was compiled by the Commonsense Computing Initiative, or a similar product. As another non-limiting example, the first semantic lexicon 202 may include WORDNET, produced by the Trustees of Princeton University, Princeton, N.J., or a similar product. As a further example, the first semantic lexicon 202 may include WIKTIONARY, produced by the Wikimedia Foundation Inc. of San Francisco, Calif., or a similar product. As a still further example, the first semantic lexicon 202 may include JMDict, produced by The Electronic Dictionary Research and Development Group of Monash University, Clayton, Australia, or a similar product. For another example, the first semantic lexicon 202 may include OpenCyc, produced by Cycorp of Austin, Tex., or a similar product. As another example, the first semantic lexicon 202 may include the Paraphrase Database (PPDB), or a similar product. The first semantic lexicon may be a combination of two or more lexicons or semantic lexicons. In some embodiments, the two or more lexicons are combined as described below in connection with FIG. 3.

In some embodiments, the system 200 includes at least one second semantic lexicon 204. The at least one second semantic lexicon 204 may be anything suitable for use as the first semantic lexicon 202.

The system 200 includes a computing device 203. The computing device 203 may be any computing device 100 as described above in connection with FIGS. 1A-B. The computing device 203 may be a server 122 or a client device 120. The computing device 203 may be a plurality of computing devices 100 working in conjunction; for instance the plurality of computing devices may perform parallel processing, or may perform sequential processing, to enact the method described below. In some embodiments, the computing device 203 is configured to identify a first term, the first term present in the first semantic lexicon, the first term absent from the term vector space, to obtain from the first semantic lexicon, at least one second term related to the first term in the first semantic lexicon, to find at least one vector in the vector space corresponding to the at least one second term, and to generate a vector corresponding to the first term using the at least one vector corresponding to the at least one second term

FIG. 3 illustrates some embodiments of a method 300 for incorporating new terms in a term-vector space from a semantic lexicon. The method 300 includes identifying, by a computing device, a first term, the first term present in a first semantic lexicon, the first term absent from a term vector space (301). The method 300 includes obtaining, by the computing device, from the first semantic lexicon, at least one second term related to the first term in the first semantic lexicon (302). The method 300 includes finding, by the computing device, at least one vector in the vector space corresponding to the at least one second term (303). The method 300 includes generating, by the computing device, a vector corresponding to the first term using the at least one vector corresponding to the at least one second term (304).

Referring to FIG. 3 in greater detail, and by reference to FIG. 2, the computing device 203 identifies a first term the first term present in the first semantic lexicon 201, the first term absent from the term vector space 202 (301). A term may be absent from the term vector space 201 where the term vector space 201 has no vector corresponding to the term. In some embodiments, the computing device 203 traverses the terms contained in the semantic lexicon and searches the term vector space 201 for each term in the traversal, identifying a term as absent from the term vector space where the term is absent from the list of terms. In some embodiments, identifying the first term further involves determining that the first term has more than a threshold number of connections to other terms within the first semantic lexicon; for instance, if a first term is connected to fewer that a threshold number of terms in the first semantic lexicon 202, the computing device 203 may ignore the term, rather than checking the term vector space to see if it is present.

The computing device 203 obtains from the first semantic lexicon 202, at least one second term related to the first term in the first semantic lexicon 202 (302). The computing device may obtain the at least one second term by locating each term directly linked to the first term in the first semantic lexicon 202; for instance, where the first semantic lexicon 202 may be represented by a graph, the first computing device 203 may retrieve all terms at nodes connected to the first term by a single edge. The computing device 203 may treat different kinds of links differently; for example the computing device 203 may allow a higher maximal number of intermediate nodes where the link is based on the terms being synonymous. The computing device 203 may ignore some kinds of links. For instance, a link showing one term is an antonym of the first term may not be a good indicator that the terms should have similar vectors; the computing device 203 may therefore ignore antonyms, and exclude them from the at least one second term.

In some embodiments, the computing device 203 determines that the at least one second term and the first term have a connection weight exceeding a threshold number. In one embodiment, the connection weight is a numerical value indicating the strength of a link between the first term and the at least one second term in the semantic lexicon. The computing device 203 may eliminate terms from the at least one second term if their connection weight to the first term is below the threshold amount. In some embodiments, the computing device 203 combines these methods. For instance, the computing device 203 may include in the at least one second term all terms directly linked to the first term, except for antonymous terms, and all terms within a maximum number of intermediate nodes of the first term that have above a certain threshold score.

The computing device 203 finds at least one vector in the vector space corresponding to the at least one second term (303). In some embodiments, the computing device 203 looks up the vector related to each term in the at least one second term, in the term vector space 201. The computing device may save the related vectors in a data structure such as a linked list or array.

The computing device 203 generates a vector corresponding to the first term using the at least one vector corresponding to the at least one second term (304). In some embodiments, where the at least one second term is a plurality of second terms and the at least one second vector is a plurality of second vectors, each second vector corresponding to a term of the plurality of second terms, the computing device 203 generates the vector corresponding to the first term by combining the plurality of second vectors together to generate the vector corresponding to the first term. The computing device 203 may combine the plurality of second vectors by computing a mean of the plurality of second vectors; the mean may be any mean that combines the second vectors and produces a vector as its output. For instance, the mean may be an arithmetic vector mean wherein the vectors are all added to each other, and the components of either each vector in the plurality of vectors or of the vector resulting from the addition are multiplied by a scalar value; e.g., n vectors may be added together, and the components of the result may be divided by n. The scalar multiplication may be performed prior to the addition. In some embodiments, the vectors are weighted prior to addition to affect the relative importance of the corresponding terms in the resulting vector. For instance, in some embodiments the computing device 203 calculates a degree of similarity between the first term and each second term, and weights each second vector of the plurality of second vectors by the degree of similarity between the first term and the second term corresponding to the second vector. The computing device 203 may calculate the degree of similarity using the connection weight provided by the semantic lexicon. The computing device 203 may calculate the degree of similarity by obtaining a relatedness confidence score. The relatedness confidence score may be calculated by determining how many distinct sources were used to determine a relationship or degree of relatedness; for instance, where the relationship between two terms was determined by crowd-sourcing, a relationship between two terms indicated by a large number of submissions may have a higher relatedness confidence score than a relationship indicated by a smaller number of submissions. The relatedness confidence score may be calculated by a computing device that creates the semantic lexicon 202; for instance, the relatedness confidence score may be assessed as data is collected to create the semantic lexicon 202. In other embodiments, the semantic lexicon 202 includes information concerning the collection of data, or raw data itself, which the computing device 203 can use to calculate the relatedness confidence score. The computing device 203 may incorporate the vector calculated for the first term into the term vector matrix; for instance, the computing device 203 may add a new row to the term vector matrix for the new term.

In some embodiments, the computing device 203 normalizes the term vector matrix after the addition of the vector associated with the first term. The computing device 203 may perform column normalization of the term vector matrix. In some embodiments, the computing device 203 performs an L_{P} normalization of each column; the normalization may be an L₁ normalization. In some embodiments, the L₁ normalization minimally penalizes distinguishing features when compared to higher values of P. The computing device 203 may also perform a row normalization on the term vector matrix. The normalization may be an L_{P} normalization; for instance, the computing device 203 may perform an L₂ normalization of each term vector.

In some embodiments, the computing device 203 retrofits the term vector space to the first semantic lexicon, producing a retrofitted term vector matrix. In one embodiment, retrofitting is a process whereby the vectors in a term vector space corresponding to terms that are close in the first semantic lexicon 202 are made to be closer each other in the term vector space. This may be implemented by creating a matrix S that represents the relationships between terms as described in the first semantic lexicon 202. The first computing device 203 may create S. In some embodiments, the first computing device 203 creates S by building a square, symmetric term-term matrix in which each cell Sᵢⱼ represents the relationship between the term represented by the ith row and the term represented by the jth column; larger values of Sᵢⱼ may represent a stronger relationship, while a value of 0 may represent a weak relationship. The entries Sᵢⱼ may be weighted by a relationship confidence score, as described above in reference to FIG. 3. The type of relationship between the terms may be omitted from the information in S. As described above in reference to finding related terms, negative relationships may be omitted from S. In other embodiments, a different computing device creates S and the first computing device 203 imports S.

In some embodiments, this is performed, given a term vector matrix W, by producing a new term vector matrix W′ that minimizes Ψ(W′)=Σᵢ₌₁^{v}[aᵢ∥wᵢ′−wᵢ∥²+Σⱼ₌₁^{v}Sᵢⱼ∥wᵢ′−wⱼ′∥²], where α is a vector or weights. In some embodiments, αᵢ is set to 0 if wᵢ=0, and 1 otherwise. In some embodiments, the computing device 203 performs the retrofitting process by computing a product of the term vector space with a matrix representing the first semantic lexicon. In some embodiments, this is performed iteratively; that is, the original term vector matrix is added to the term vector matrix and then multiplied by S at least a second time. For instance, for a number of iterations, each intermediate value w^{K+1} may be derived from W^{K} by calculating W^{K+1}=(SW^{K}+a⊚W)Ø(\vec{1}+a), where ⊚ denotes row-wise multiplication, Ø represents row-wise division, and \vec{1} is a vector containing all ones. In some embodiments, this is repeated for ten iterations. Generally, the retrofitted term vector matrix may be retrofitted to the first semantic lexicon 202 a second or multiple times.

In some embodiments, the first computing device 203 performs additional steps in the retrofitting process to ensure that the original values of the vectors in the term vector matrix also affect the retrofitted term vector matrix. In some embodiments, the first computing device averages each vector with itself to maintain each vector close to its original position as determined by its original value in the term vector matrix. In some embodiments, where the matrix representing the first semantic lexicon is a square matrix having a plurality of diagonal cells, the computing device averages each vector with itself by weighting each diagonal cell of the plurality of diagonal cells; in some embodiments, this weighting may be performed by adding one to each diagonal value. In some embodiments, the computing device 203 performs row normalization, as described above in reference to FIG. 3 on the retrofitted term vector matrix. In other embodiments, the computing device 203 performs column normalization on the retrofitted term vector matrix. In still other embodiments, the computing device 203 performs both row and column normalization on the retrofitted term vector matrix. In some embodiments, the computing device 203 retrofits the retrofitted term vector matrix to a second semantic lexicon 204.

The first computing device 203 may perform standardization to the terms in the first semantic lexicon 202 and the term vector space 201 so that both the first semantic lexicon 202 and the term vector space 201 treat the same terms as distinct or identical. In some embodiments, the term vector space 201 treats two terms as distinct where the first semantic lexicon 202 does not. For instance, the computing device 203 may identify a plurality of terms in the term vector space that correspond to a single term in the first semantic lexicon and combine a plurality of vectors representing the plurality of terms together into a single vector representing the single term. In some embodiments, the computing device 203 combines the plurality of vectors by computing a weighted average of the plurality of vectors. The average may be weighted by frequency of each of the plurality of terms. In some embodiments, the term vector space 201 or information concerning the term vector space 201 that is available to the computing device 203 describes the frequency of each term in the term vector space 201. In other embodiments, the computing device 203 can determine from the term vector space 201 the order of frequency of the terms in the term vector space 201; the computing device 203 may therefore be able to estimate the frequency of each term using Zipf's law, which holds that generally, the nth term in frequency order has frequency proportional to 1/n.

In other embodiments, a plurality of terms in the first semantic lexicon 202 maps to a single term in the term vector space 201. For instance, the first semantic lexicon 202 may treat accented and accented words in a language like Spanish as different terms, while the term vector space 201 ignores accents. In some embodiments, the computing device 203 combines the plurality of terms in the first semantic lexicon 202; the computing device 203 may, for instance, make a single list showing containing all relationships from the plurality of terms.

In some embodiments, the computing device 203 generates the first semantic lexicon by combining a second semantic lexicon and a third semantic lexicon. In some embodiments, the computing device 203 collects a set of terms from the second and third semantic lexicon, and combines the relationships for the set of terms from both the second and third semantic lexicon, for instance creating a matrix S, or a vector set, representing the relationships from the second and third semantic lexicons. In some embodiments, the computing device 203 scales relationship confidence scores so that the relationship confidence scores in each of the second semantic lexicon and the third semantic lexicon average to the same amount; for instance, the relationship confidence scores for the second and third semantic lexicon may be scaled so that the average relationship confidence score in the second semantic lexicon is 1, and the average relationship confidence score in the second semantic lexicon is also one, which may be accomplished by dividing all relationship confidence scores in each semantic lexicon by the average confidence score in that semantic lexicon. This rescaling may ensure that the relationship confidence scores do not skew to relationships in a semantic lexicon that uses a larger scale to measure confidence scores.

Although the foregoing systems and methods have been described in some detail for purposes of clarity of understanding, it will be apparent that certain changes and modifications may be practiced within the scope of the appended claims.

What is claimed is:

1. A method for incorporating new terms in a term vector space from a semantic lexicon, the method comprising:
identifying, by a computing device, a first term, the first term present in a first semantic lexicon, the first term absent from a term vector space represented by a term vector matrix;
obtaining, by the computing device, from the first semantic lexicon, at least one second term related to the first term in the first semantic lexicon;
finding, by the computing device, at least one vector in the vector space corresponding to the at least one second term; and
generating, by the computing device, a vector corresponding to the first term using the at least one vector corresponding to the at least one second term.

2. The method of claim 1, wherein identifying further comprises determining that the first term has more than a threshold number of connections to other terms within the first semantic lexicon

3. The method of claim 1, wherein obtaining further comprises determining that the at least one second term and the first term have a connection weight exceeding a threshold number.

4. The method of claim 1, wherein the at least one second term is a plurality of second terms, wherein the at least one second vector is a plurality of second vectors, each second vector corresponding to a term of the plurality of second terms, and wherein generating further comprises combining the plurality of second vectors together to generate the vector corresponding to the first term.

5. The method of claim 4, wherein combining the plurality of second vectors further comprises computing a mean of the plurality of second vectors.

6. The method of claim 5, wherein computing the mean further comprises:
calculating a degree of similarity between the first term and each second term; and
weighting each second vector of the plurality of second vectors by the degree of similarity between the first term and the second term corresponding to the second vector.

7. The method of claim 6, wherein calculating the degree of similarity further comprises obtaining a relatedness confidence score.

8. The method of claim 4, wherein combining the plurality of second vectors further comprises weighting each second vector of the plurality of second vectors by a reliability score.

9. The method of claim 1 further comprising performing column normalization of the term vector matrix.

10. The method of claim 1 further comprising performing row normalization of the term vector matrix.

11. The method of claim 1, further comprising retrofitting the term vector space to the first semantic lexicon, producing a retrofitted term vector matrix.

12. The method of claim 11, wherein retrofitting further comprises computing a product of the term vector space with a matrix representing the first semantic lexicon.

13. The method of claim 12 further comprising adding the retrofitted term vector matrix to the term vector matrix to produce an intermediate matrix, and computing the product of the intermediate matrix with the matrix representing the first semantic lexicon.

14. The method of claim 12, wherein the matrix representing the first semantic lexicon is a square matrix having a plurality of diagonal cells, and further comprising weighting each diagonal cell of the plurality of diagonal cells.

15. The method of claim 11 further comprising retrofitting the retrofitted term vector matrix to the first semantic lexicon.

16. The method of claim 11 further comprising computing the mean of each vector in the term vector space with itself, and replacing each vector in the term vector space with the computed mean.

17. The method of claim 11 further comprising retrofitting the retrofitted term vector space to a second semantic lexicon.

18. The method of claim 1, further comprising:
identifying a plurality of terms in the term vector space that correspond to a single term in the first semantic lexicon; and
combining a plurality of vectors representing the plurality of terms together into a single vector representing the single term.

19. The method of claim 18, wherein combining further comprises computing a weighted average of the plurality of vectors.

20. The method of claim 1 further comprising generating the first semantic lexicon by combining a second semantic lexicon and a third semantic lexicon.

21. A system for incorporating new terms in a term-vector space from a lexicon, the system comprising:
a term vector space;
a first semantic lexicon; and
a computing device, the computing device configured to identify a first term, the first term present in the first semantic lexicon, the first term absent from the term vector space, to obtain from the first semantic lexicon, at least one second term related to the first term in the first semantic lexicon, to find at least one vector in the vector space corresponding to the at least one second term, and to generate a vector corresponding to the first term using the at least one vector corresponding to the at least one second term.
